(19) United States
(12) Patent Application Publication
(10) Pub. No.: US 2010/0206979 A1
(43) Pub. Date: Aug. 19, 2010

(54) RESET LINKAGE ASSEMBLY FOR BLOCKING SHIELD OF MULTI-ROLL PAPER DISPENSER

(76) Inventor: Scott J. Collins, Milwaukee, WI (US)

Correspondence Address: BOYLE FREDRICKSON S.C., 840 North Plankinton Avenue, MILWAUKEE, WI, 53203, US

(21) Appl. No.: 12/706,738

(22) Filed: Feb. 17, 2010

Related U.S. Application Data
(60) Provisional application No. 61/153,175, filed on Feb. 17, 2009.

(51) Int. Cl. B65H 19/10; G05G 11/00

(52) U.S. Cl. 242/560; 74/479.01

(57) ABSTRACT

The present invention provides a linkage assembly that is pivotal along a first axis of rotation to cause rotation of another object along a second axis of rotation that is substantially orthogonal to the first axis of rotation. The linkage assembly can therefore be used as a motion transfer device, such as for a paper dispenser, or other assemblies in which it is desired to cause the automatic movement on component upon actuation of another component where components have different axes of rotation.

### CROSS-REFERENCE TO RELATED APPLICATIONS

This application claims the benefit of U.S. Ser. No. 61/153,175, filed Feb. 17, 2009, and entitled “Hands Free Mechanism for Opening Paper Access Door in a Roll Tissue Paper Dispenser.”

### BACKGROUND AND SUMMARY OF THE INVENTION

For hygienic purposes as well as reduced consumer apprehension with regard to the spread of bacteria and other germs, hands-free paper dispensers, such as paper towel dispensers, are increasingly being used in high-volume applications, such as malls, restaurants, schools and universities, hospitals and clinics, theaters, and arts and sports venues. Additionally, multi-roll dispensers are being used in such high-traffic areas to limit the frequency at which service personnel must restock the dispensers and thus increase the likelihood that a dispenser will contain a usable amount of paper. For this reason, toilet paper dispensers that are used in public washrooms are often designed to hold a minimum of two rolls of toilet paper—a primary roll and a reserve roll. While such multi-roll dispensers are designed to house more than one roll of paper, there is generally a desire to limit access to the reserve roll until after the primary roll has been substantially exhausted. While a number of limiting devices have been developed, it is common for a multi-roll dispenser to have a shield or door that must be manually moved to expose the reserve roll, but can only be moved when the primary roll is (or is nearly) exhausted. Given the public anxieties associated with the transfer of bacteria and germs generally, user contact with anything of the dispenser other than the paper that is being actively withdrawn from the dispenser is considered by many users to be unsanitary and thus unwelcome. Thus, there is a general hesitation and reluctance of many users to manually move the shield to expose the reserve roll when needed. Still further, users unfamiliar with multi-roll dispensers may not have an understanding as to the necessity or operation of moving the shield.

While the incorporation of such shields has proven to be effective in reducing access to the reserve roll until exhaustion of the primary roll, conventional dispensers require service personnel to reset the shield when recharging or reloading the dispenser. If the shield is not properly reset, both rolls will be accessible and the benefits that would otherwise be provided by the shield are lost.

The present invention is directed to a multi-roll dispenser that overcomes the aforementioned drawbacks. In one embodiment, the dispenser includes a shield that blocks access to a reserve roll until after a primary roll has been substantially exhausted. When the primary roll is substantially exhausted, the shield is automatically moved clear of the reserve roll to permit access to the reserve roll. The dispenser also includes a reset assembly that automatically returns the shield to its “blocking” position when the cover of the dispenser is opened. In this regard, the invention neither requires a user to manually move the shield to clear the reserve roll nor manually move the shield back to its blocking position when the dispenser is recharged. Further, in a preferred embodiment, cooperating mechanical linkages are used to move the shield from its blocking position and to reset the shield, thereby avoiding the complexities of electrical based systems that rely upon on proximity sensors and require a power supply, e.g., batteries, to move and reset the shield.

It is therefore an object of the invention to provide a paper or web dispenser, such as a toilet tissue dispenser, that allows a user to gain access to a reserve roll without being required to manually move a shield or door that otherwise prevents access to the reserve roll.

It is another object of the invention to provide a reliable device for automatically moving a shield or door from a position that bars access to a reserve roll of paper to a position that permits access to the reserve roll when a primary roll is deemed to be (nearly) exhausted.

It is yet another object of the invention to provide a multi-roll toilet paper dispenser that limits access to only a primary roll until the primary roll is (nearly) exhausted and then automatically rotates or slides a shield or door that is otherwise biased to prevent access to a reserve roll to thereby permit access to the reserve roll.

It is a further object of the present invention to provide a motion transfer device that is usable with a multi-roll web material dispenser having a blocking shield that automatically returns the blocking shield to its blocking position when the front cover to the dispenser is opened.

It is yet another object of the invention to provide a linkage assembly operative as a motion transfer device that is pivotal about a first axis of rotation to cause rotation of a rotary object about a second axis of rotation that is at an angle to the first axis of rotation.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE FIGURES

Preferred exemplary embodiments of the invention are illustrated in the accompanying drawings in which like reference numerals represent like parts throughout.

In the drawings:

FIG. 1 is an isometric view of a toilet paper dispenser configured to dispense toilet paper from a primary roll and then a reserve roll when the primary roll is substantially exhausted, and including a shield that blocks access to the reserve roll until the primary roll is substantially exhausted and a linkage assembly for resetting the shield when the front cover of the dispenser is opened according to one aspect of the invention;

FIG. 2 is a front elevation view of the dispenser of FIG. 1 with the front cover removed for simplicity, and charged with a primary roll and a reserve roll and with access to the reserve roll blocked by the shield positioned generally below the reserve roll;

FIG. 3 is a front elevation view of the dispenser of FIG. 1 with the front cover removed for simplicity, and the primary roll exhausted and the shield moved to a raised position to expose and allow access to the reserve roll;

FIG. 4 is a front elevation view of the dispenser of FIG. 1 with the front cover removed for simplicity and ready for recharging with a primary roll and a reserve roll;

FIG. 5 is a rear elevation view of the dispenser of FIG. 1 and shown in the unloaded condition of FIG. 4;

FIG. 6 is a front isometric view of the dispenser of FIG. 1 with the front cover pivoted downward to an opened position to expose the internal volume of the dispenser for recharging of the dispenser and the shield automatically moved to its blocking position upon substantial opening of the front cover by the linkage assembly according to one aspect of the invention;

FIG. 7 is a rear isometric view of the dispenser of FIG. 1 shown with the front cover pivoted downward to an opened position to expose the internal volume of the dispenser for recharging of the dispenser and the shield automatically moved to its blocking position upon substantial opening of the front cover by the linkage assembly according to one aspect of the invention;

FIG. 8 is an enlarged view of a portion of the linkage assembly of the present invention;

FIG. 9 is an isometric view of the linkage assembly of the present invention and its interfacing with a reset assembly of the dispenser of FIG. 1, and shown in the position corresponding to the primary and reserve rolls being substantially exhausted;

FIG. 10 is an isometric view of the linkage assembly of FIG. 9 with a cover link of the linkage assembly pivoted downward in response to movement of the front cover of the dispenser;

FIG. 11 is an isometric view of the linkage assembly of FIGS. 9 and 10 with an cam of the linkage assembly rotated about a first axis of rotation in response to further pivoting of the front cover away from the dispenser resulting in pivoting of a lift arm of the reset assembly of the dispenser downward to cause rotation of the shield about a second axis of rotation orthogonal to the first axis of rotation to move the shield to its blocking position; and

FIG. 12 is a rear isometric view of the dispenser with the several components of the reset assembly shown in the positions that correspond to a fully charged dispenser and the front cover in a fully raised and closed position.

### DETAILED DESCRIPTION OF THE INVENTION

The present invention is directed to a linkage assembly that is pivotal along a first axis of rotation to cause movement, e.g., rotation, of another object along a second axis, e.g., a second axis of rotation, that is preferably substantially orthogonal to the first axis of rotation. The linkage assembly will be described with respect to a multi-roll toilet paper dispenser having a shield that blocks access to a reserve roll of paper until substantial exhaustion of a primary roll of paper. It will be appreciated however that the invention may be used with other types of dispensers and may also be used with other systems altogether. Thus, the invention is not limited to the dispenser described herein and it should therefore be appreciated that the dispenser represents merely one exemplary operating environment for the present invention. Additionally, the components of the linkage assembly will be described relative to their interaction with the components of a multi-roll toilet paper dispenser, but it should be understood that these terms are being used to relate the components of the linkage assembly to the dispenser and are not intended, nor should they be considered, to limit the functionality of the linkage assembly or its applicability with other types of devices. Additionally, while the linkage assembly will be described as causing rotation of a rotary object, it is understood that the linkage assembly could be used to move other types of objects, such as a slide, pull, pushbutton, or other non-rotary objects.

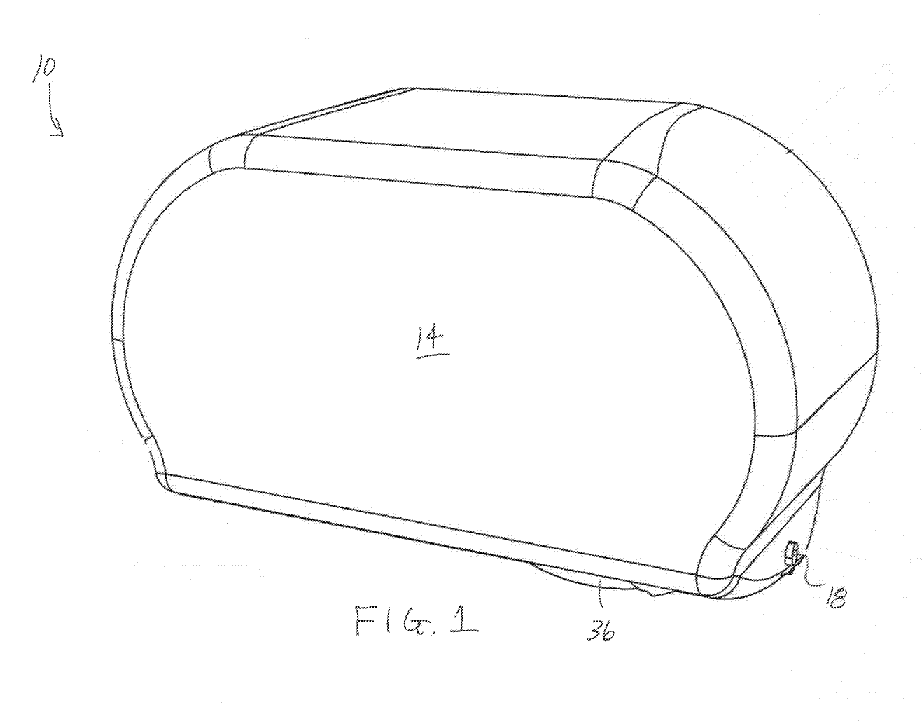

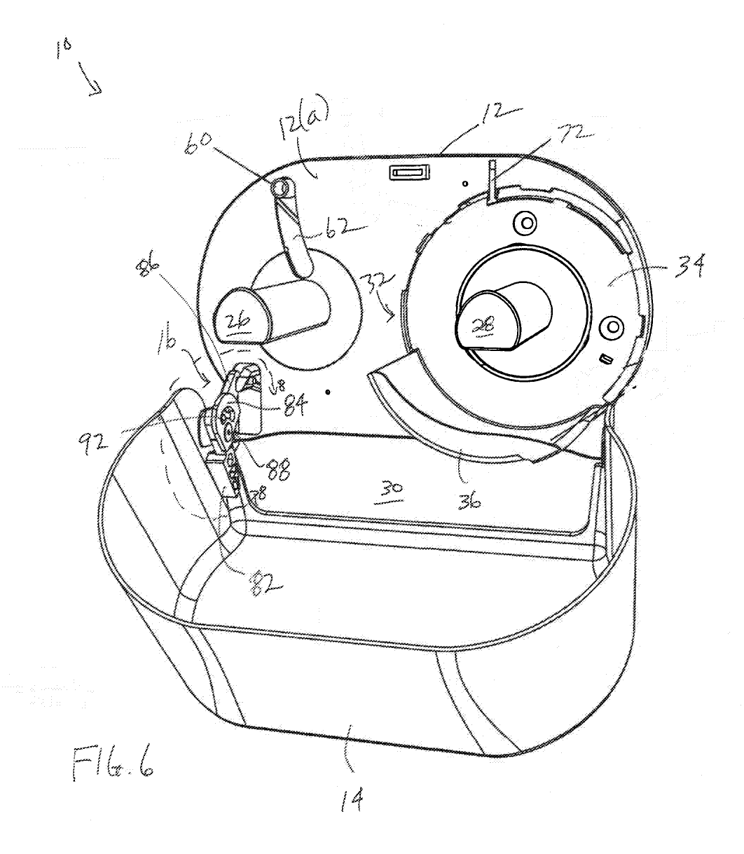

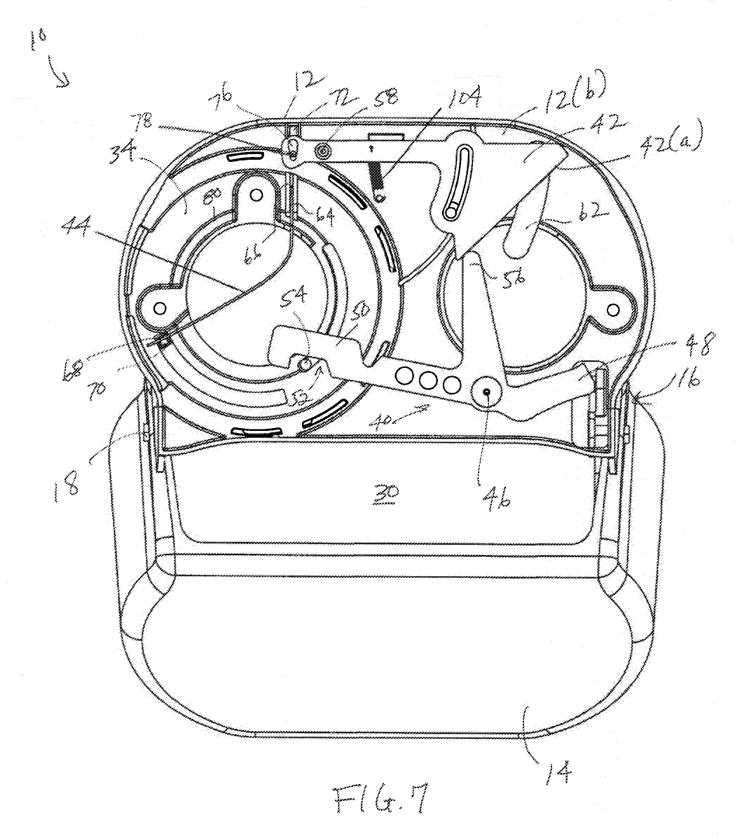

With reference now to FIGS. 1 through 5, dispenser 10 includes a rear panel 12 and a front cover 14 that is pivotally coupled to the rear panel 12 by a linkage assembly 16, which will be described in greater detail with respect to FIGS. 8 through 12, and a hinge pin 18. The linkage assembly 16 and the hinge pin 18 are located at a lower end of the rear panel 12 and thus the front cover 14 is designed to pivot relative to the lower or bottom end of the rear panel 12. The linkage assembly 16 and the hinge pin 18 provide a permanent connection of the front cover 14 to the rear panel 12 but allow access to the rear panel 12, and its components, by simply pivoting the front cover 14 away from the rear panel 12 to a position generally below the rear panel, as shown in FIGS. 6 and 7.

When the front cover 14 is in its raised, closed position, as shown in FIG. 1, the rear panel 12 and the front cover 14 collectively define an internal volume sized to accommodate a pair of rolls of toilet paper, e.g., a primary roll 22 and a reserve roll 24. The rear panel 12 includes a primary mandrel 26 and a reserve mandrel 28 that extend outwardly from the front face 12(a) of the rear panel 12. The mandrels 26, 28 are generally vertically centered on the rear panel 12 and are parallel to one another. The mandrels 26, 28 are oriented horizontally on the rear panel 12 so as to be aligned over an enlarged opening 30 formed at the bottom of the dispenser 10 and, more particularly, in a lower portion of the front cover 14. The enlarged opening 30 can be easily seen in FIG. 6. The enlarged opening 30 is sized such that paper can be dispensed from both rolls 22, 24.

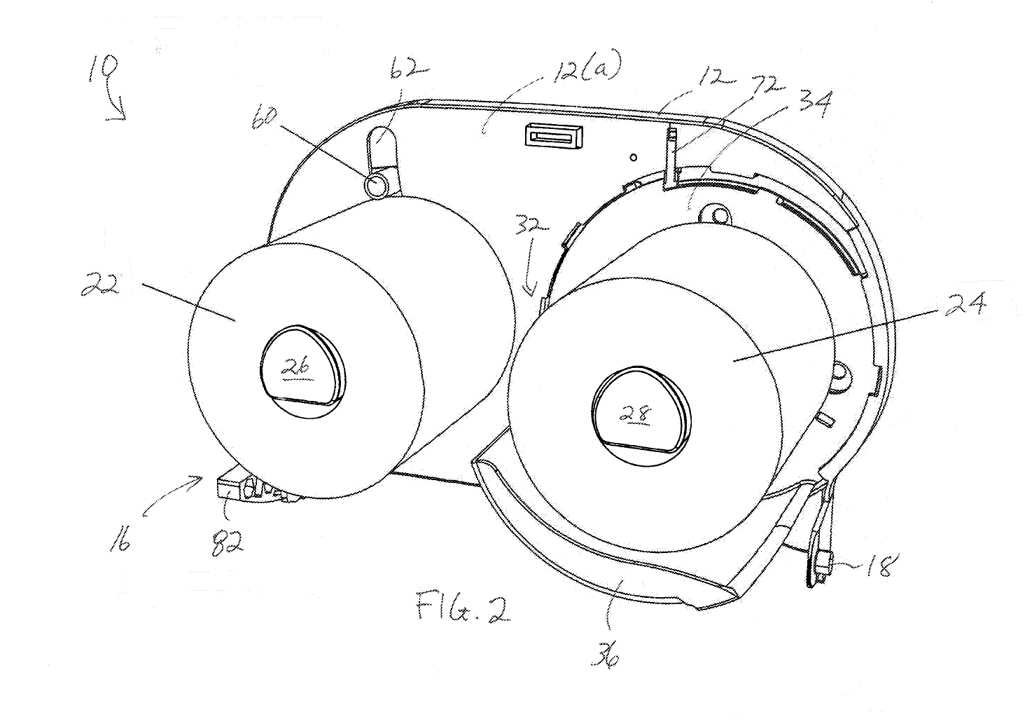

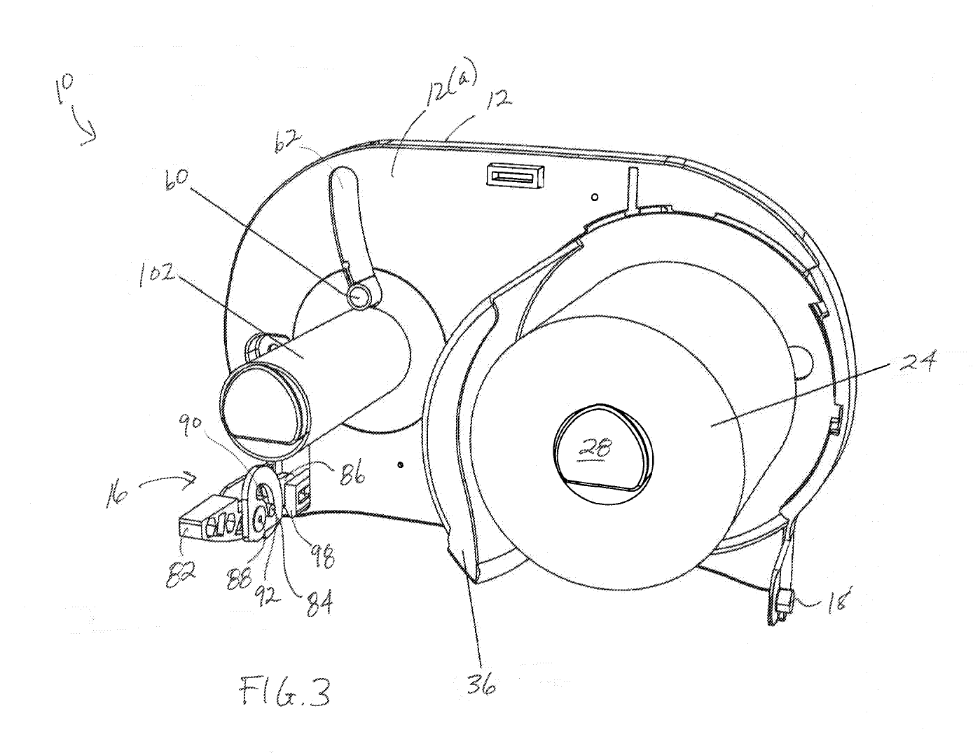

The dispenser 10 includes a shield assembly 32 rotatably coupled to the rear panel 12 and operative to block access to the reserve roll 24 until the primary roll 22 is substantially exhausted. The shield assembly 32 generally consists of a disc 34 having a central opening through which mandrel 28 extends and a curvilinear flange 36. When the shield assembly 32 is in the blocking position, FIG. 2 for example, the flange 36 is positioned beneath the reserve roll 24 in the enlarged opening 30. As will be explained more herein, when the primary roll 22 is substantially exhausted, the shield assembly 32 rotates clockwise from the lowered, blocking position to a raised position generally between the two mandrels 26, 28, as shown in FIG. 3. In this raised position, a user's hand may access the reserve roll 24 through the enlarged opening 30. It should also be noted that the any paper remaining on the primary roll 22 may also be accessed when the flange 36 has been rotated out of the opening to the position shown in FIG. 3. However, as will be described, it is preferred that that flange 36 is not rotated out of the enlarged opening 30 until after the primary roll 22 has been substantially, if not completely, exhausted.

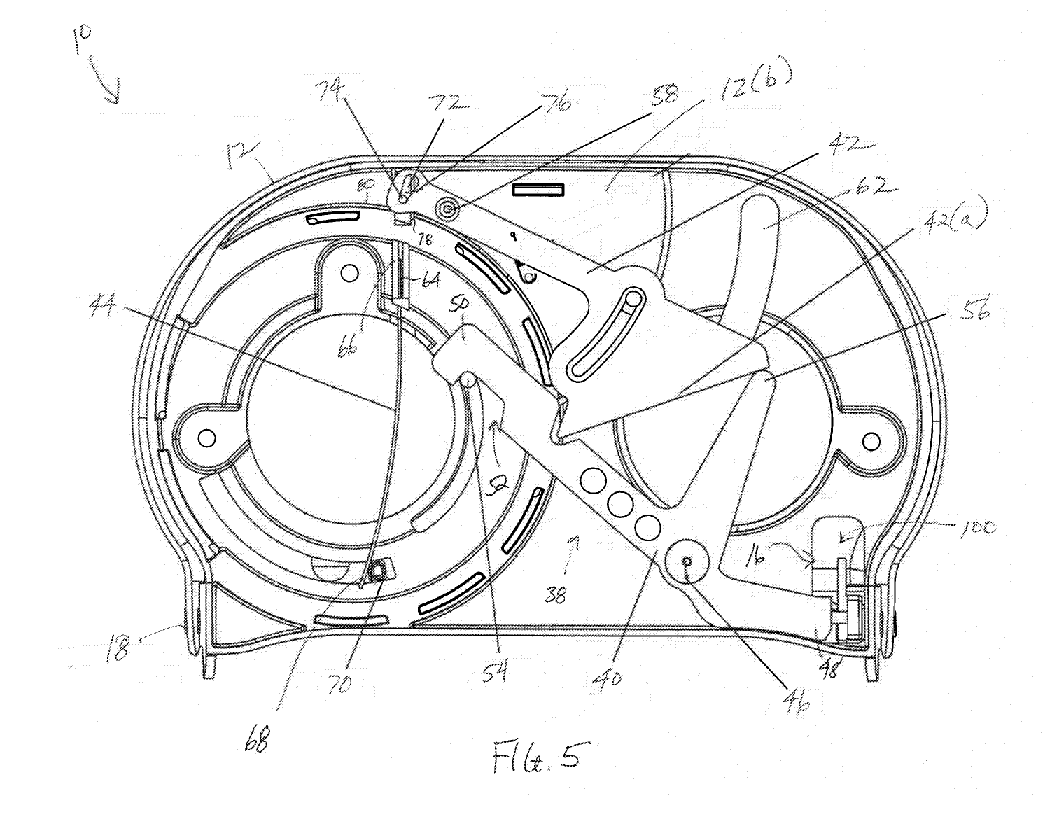

To reduce user contact with the dispenser 10, a reset assembly (generally designated by reference numeral 38 in FIG. 5) is provided that interacts with the shield assembly 32 to cause the flange 36 to move from the blocked position to the raised position automatically when the primary roll is substantially exhausted. As will also be described, the reset assembly 38 interacts with the linkage assembly 16 to return the flange 36 to the blocking position in a hands-free manner. The reset assembly 38 generally consists of a lift arm 40, a follower arm 42, and a biasing element, e.g., spring wire 44. The lift arm 40 is pivotally mounted to the back side 12(b) of the rear panel 12 at pivot pin 46. The lift arm 40 has a first end 48 that is connected to the linkage assembly 16 and as will be described responds to movement of the linkage assembly 16 when the front cover 14 is opened. The lift arm 40 has a second end 50 generally opposite the first end 48 and includes a notch 52 that receives a pin 54 extending from a back side of the disc 34. The lift arm 40 also has a lifter tip 56 generally defined between the first and second ends 48, 50. The lifter tip 56 applies a lifting force to the follower arm 42, e.g., angled edge 42(a), as the lift arm 40 is rotated in a counterclockwise direction in response to opening of the front cover 14.

The follower arm 42 is mounted to the back side 12(b) of the rear panel 12 at pivot pin 58. The follower arm 42 includes a roll follower 60 that extends through a curvilinear slot 62 formed in the rear panel 12. As shown in FIG. 2, the roll follower 60 rests against an outermost surface of the primary roll 22. As paper is withdrawn from the primary roll 22 and the diameter of the roll 22 decreases, the roll follower 60 will gradually lower, i.e., move closer to mandrel 26, as it pivots about pivot pin 58.

The aforementioned biasing element is preferably a spring wire 44 that has a first end 64 fixedly received in a slot 66 formed in the back side 12(b) of the rear panel 12. Opposite the first end 64 is a second end 68 that engages a tab 70 extending rearwardly from the back side of the disc 34. A slide latch 72 is slidably mounted to the rear panel 12 and includes a post 74 that extends through a slot 76 formed in the follower arm 42 generally adjacent pivot pin 58. When the dispenser 10 is charged, the post 74 is seated in a cutout 78 formed in the peripheral edge 80 of the disc 34 adjacent the back side 12(b) of the rear panel 12. With brief reference to FIG. 7, when the dispenser 10 is charged, the disc 34 is rotated clockwise relative to the position shown in FIG. 5 and the post 74 is seated in the cutout 78. On the other hand, and referring back to FIG. 5, when the primary roll 22 has been substantially exhausted, the post 74 is forced upward by pivoting of the follower arm 42 in a clockwise direction about pivot pin 58, which results in the slide latch 72 being withdrawn from the cutout 78. When this occurs, the tension stored in the spring wire 44 is released to rotate the disc 34 in a counterclockwise direction to rotate the flange 36 to the raised position. This rotation of the disc 34 rotates the pin 54 into the notch 52 of the lift arm 40, as shown in FIG. 5.

As referenced above, the present invention provides a linkage assembly 16 that interfaces with the reset assembly 38 to move the flange 36 between the raised and lowered positions automatically in a hands-free manner. Referring now to FIG. 8, the linkage assembly 16 generally consists of a cover link 82, an cam 84, and a lift arm link 86. The cover link 82 is interconnected between an inside surface of the front cover 14 and the cam 84. The cover link 82 is pivotal relative to the cam 84 at pivot pin 88, and the cam 84 includes a curved slot 90. The cover link 82 includes axially extending post 92 that is received within the curved slot 90 and moves along the curved slot 90 as the front cover 14 is opened.

The lift arm link 86 is fixedly coupled to the cam 84 and also includes an axially extending post 94. Post 94 is received within a slot 96 in a forwardly extending segment 98 of the lift arm 40. As shown in FIG. 8, the segment 98 extends through an opening 100, formed in the rear panel 12, and provides a connection between the linkage assembly 16 and the lift arm 40 of the reset assembly 38.

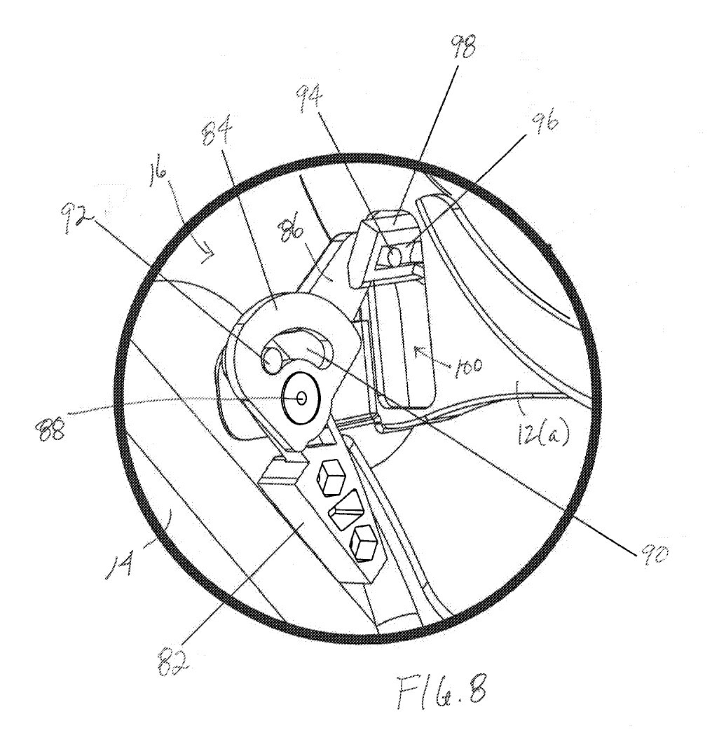

Referring now to FIGS. 9-11, the linkage assembly is movable between three general positions. FIG. 9 shows the position of the linkage assembly 16 when the front cover 14 is in the closed position, and the primary roll 22 has been substantially exhausted and thus the disc 34 has rotated to move the flange 36 to the raised position, as shown in FIGS. 3 through 5. In this position, the lift arm 40 is pivoted upward as a result of the tension in the spring wire 44 being released upon upward movement of the slide latch 72.

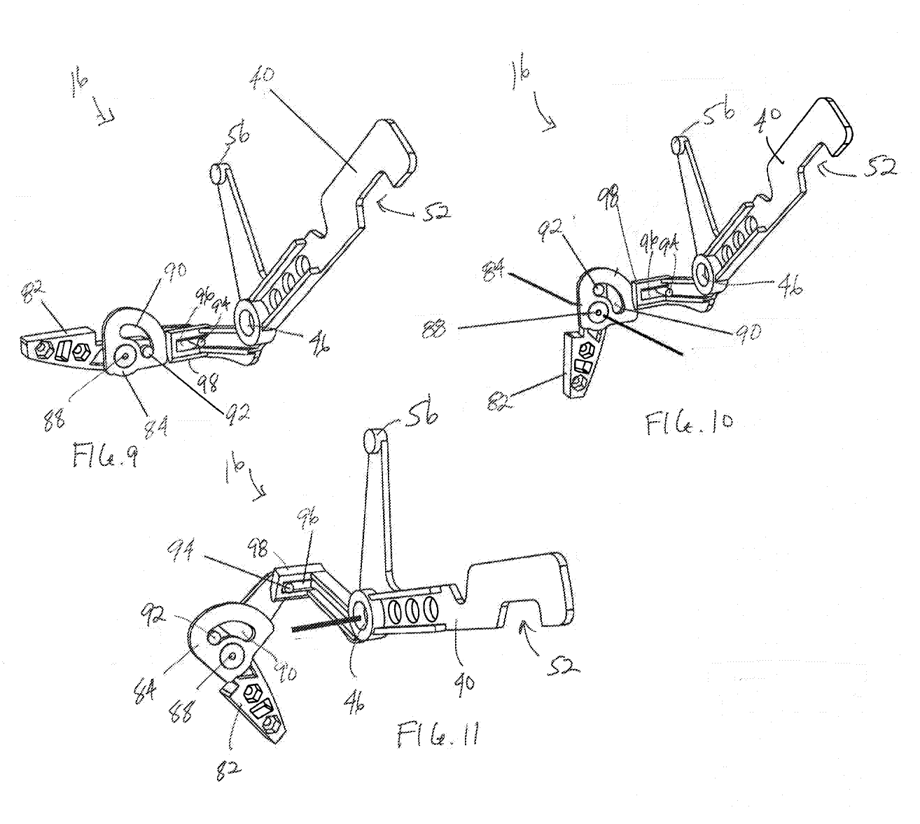

FIG. 10 illustrates the position of the linkage assembly 16 when the front cover 14 has been pivoted away from the rear panel 12 to a partially open position. That is, the curved slot 90 formed in the cam 84 defines a first range of travel for the front cover 14. As the front cover 14 is pivoted away from the rear panel 12, the post 92 rotates with the front cover 14 and thus moves along the curved slot 90, as best shown in a comparison of FIGS. 9 and 10. As also illustrated in FIG. 10, when the post 92 has reached the end of the curved slot 90, the cover link 82 is oriented generally perpendicular to its position when the front cover is closed. Thus, in one preferred embodiment, the slot 90 provides approximately ninety degrees of rotation for the front cover 14.

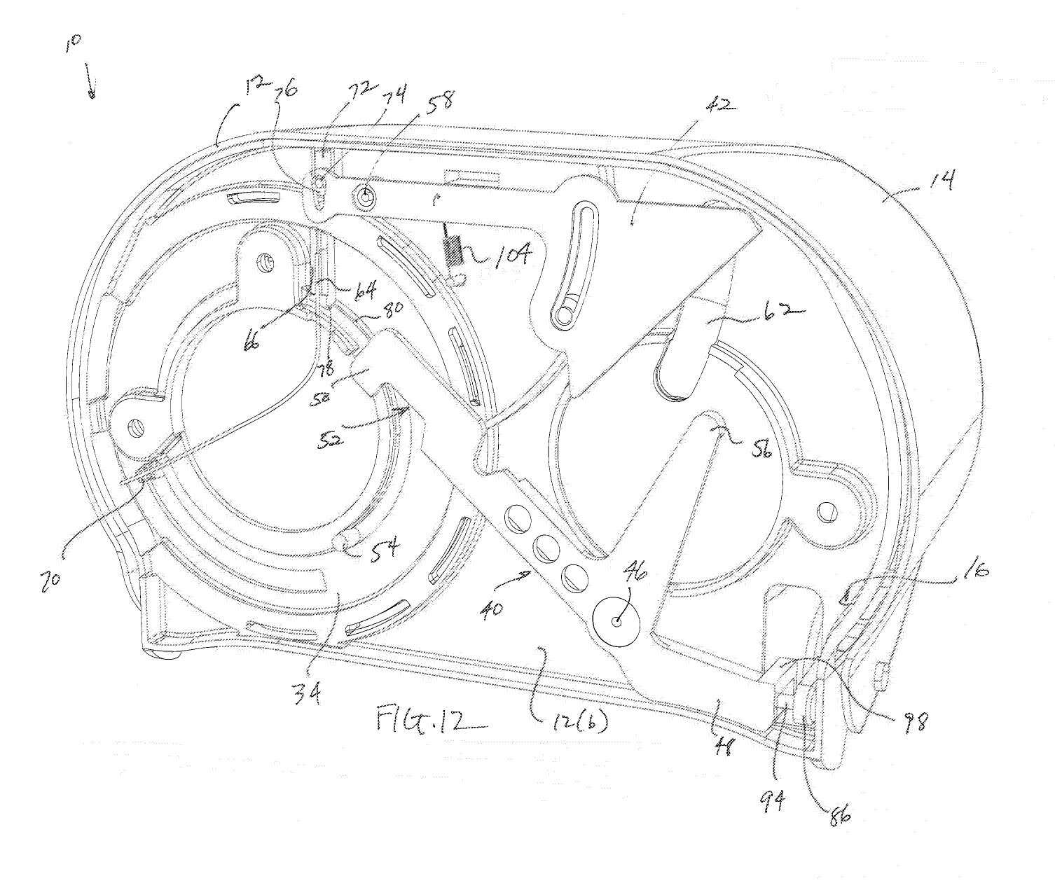

However, the pivotal relationship between the cam 84 and the lift arm link 86 permits additional rotation of the front cover 14, as shown in FIG. 11. As the front cover 14 is further rotated to the position shown in FIGS. 6 and 7, the cam 84 pivots forward along a second range of travel. This pivoting or rotation of the cam 84 pulls post 94 along slot 96 formed in the lift arm segment 98. A comparison of FIGS. 10 and 11 shows this movement of the post 94 within slot 96. Moreover, as the cam 84 rotates forward, the lift arm link 86 is raised, as shown in FIG. 11. Raising of the lift arm link 86 causes an opposite movement in the lift arm 40. That is, the lift arm 40 is rotated downward as the lift arm link 86 is rotated upward, as also shown in FIG. 11. With additional reference to FIG. 7, as the lift arm link 86 is rotated upward, the lift arm 40 is caused to rotate downward (or counterclockwise in FIG. 7) which in turn causes the lift arm 40 to push pin 54 in a clockwise direction to reset the disc 34 and the spring wire 44. Moreover, this movement of the lift arm 40 forces the follower arm 42 to be pushed upward so that the roll follower 69 is spaced from mandrel 28 as shown in FIG. 6. The dispenser 10 is then ready to be recharged with two new rolls of tissue paper.

The several stages of operation for the dispenser 10 and, more particularly, the linkage assembly 16 and its interfacing with the reset assembly 38 will now be described. For purposes of detailing the operational stages, the discussion will begin with the assumption that the dispenser 10 has been charged with two full rolls of toilet paper, e.g., primary roll 22 and reserve roll 24. In this stage, and referring to FIGS. 1 and 2, the front cover 14 is closed, the roll follower 60 is held against an outer periphery of the primary roll 22, and the spring wire 44 is held in tension. As shown in FIGS. 1 and 2, the shield assembly 32 is arranged such that the flange 36 is positioned beneath the reserve roll 24, thereby blocking access to the reserve roll 24.

As paper is withdrawn from the primary roll 22, the diameter of the primary roll 22 will decrease, and the roll follower 60 will gradually move downward in slot 62. When the primary roll 22 is substantially exhausted, leaving a stub roll 102 on mandrel 26, the roll follower 60 will have moved to the lowermost end of the slot 62, as shown in FIG. 3. When the roll follower 60 has substantially reached this lowermost position, the slide latch 72, as shown in FIG. 5, is pulled upward which releases the spring wire 44. The tension stored in the spring wire 44, when released, causes the spring wire 44 to apply a pushing force against tab 70 extending from the back side of the disc 34. This force ultimately rotates the disc 34 in a counterclockwise direction (from the vantage point shown in FIG. 5) which in turn causes the flange 36 to be rotated in a clockwise direction (from the vantage point shown in FIG. 3). That is, the flange 36 is moved out of the enlarged opening 30 to expose the reserve roll 24, as shown in FIG. 3. In this position, the paper of the reserve roll 24 can be accessed and used accordingly.

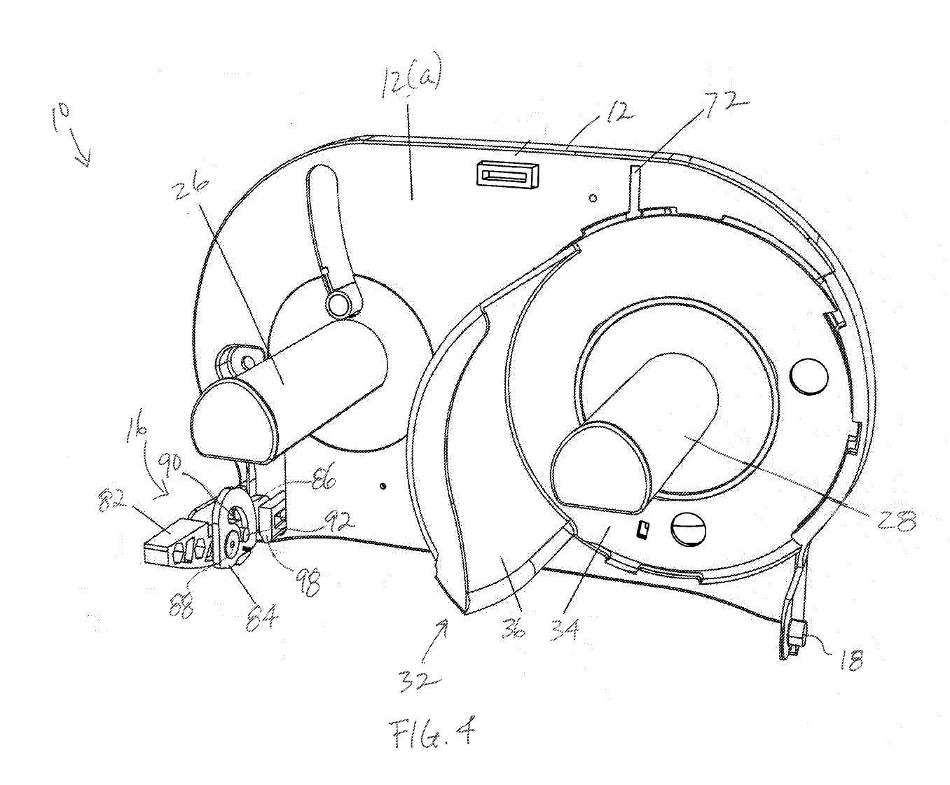

When both the primary and reserve rolls 22, 24 have been substantially exhausted (FIG. 4), the dispenser 10 is ready for recharging. Accordingly, when a service person unlocks the front cover 14 from the rear panel 12 in a known manner and then rotates the front cover 14 downward, as shown in FIG. 8, the cover link 82 rotates downward which draws the pivot pin 88 forward in curved slot 90. As the front cover 14 is further rotated downward, the lift arm link 86 is pulled upward, as shown in FIG. 6, which causes the first end 48 of the lift arm 40 to rotate counterclockwise about pivot pin 46 as shown in FIG. 7. Similarly, the second end 50 of the lift arm 40 rotates about pivot pin 46 and in doing so pushes pin 54 downward, which causes the disc 34 to rotate in a clockwise direction. Rotation of the disc 34 in this direction forces tab 70 against the spring wire 44 to load the spring wire 44 as also shown in FIG. 7. As the flange 36 of the shield assembly 32 is connected to the disc 34, rotation of the disc 34 also causes the flange 36 to be lowered back to its blocking position, as illustrated in FIGS. 2 and 6. It will thus be appreciated that when the front cover 14 is lowered to the position shown in FIGS. 6 and 7, the flange 36 is reset and the spring wire 44 is loaded.

Additionally, as the lift arm 40 is rotated counterclockwise in FIG. 7, the lifter tip 56 forces the follower arm 42 to its reset position spaced from the mandrel 28 for the reserve roll, as shown in FIGS. 6 and 7. Thus, FIG. 6 illustrates the position of the flange 36, the front cover 14, and the roll follower 60 when the dispenser 10 is ready for recharging.

After the primary and reserve rolls 22, 24 have been recharged, the roll follower 60 will fall, under the force of gravity, against the primary roll 22, as shown in FIG. 2. A coil spring 104, as shown in FIG. 12, is also provided to draw the follower arm 42, and thus the roll follower 60 against the outer surface of the primary roll 22 and maintain that engagement as the primary roll 22 is exhausted. The front cover 14 may then be raised from its open position to its closed position, FIG. 1, and locked in place against the rear panel 12 using a conventional locking mechanism (not shown). When the front cover 14 is rotated upward to the raised position shown in FIG. 1, the various components of the linkage assembly 16 return to the positions shown in FIG. 9. FIG. 12 shows the positions of the several components of the dispenser 10 when the dispenser is charged with two full rolls of toilet paper and the front cover is in the closed position.

In this position, the shield assembly has been reset, the lift arm has been reset, and the linkage assembly has been reset, all without requiring a user to separately and manually reset each of these components. Moreover, as described herein, the shield exposes the reserve roll automatically upon exhaustion of the primary roll. As such, a user can access the paper of the reserve roll without manually sliding the shield clear of the reserve roll. Therefore, it will be appreciated that, in one embodiment, the present invention provides a multi-roll toilet paper dispenser that is hands-free in exposure of an otherwise shielded reserve roll and is also hands-free in resetting the shield for the reserve roll to its blocking or shielding position.

As noted above, the multi-roll toilet paper dispenser 10 represents one application for the present invention. It is therefore understood that the invention could be used with other applications where it is desired to cause movement, e.g. rotation or translation, of one component based on rotation of another component when the two components have different, e.g., orthogonal, axes or planes of movement. For example, the invention could also be used with a cabinet, such an electrical panel, and be implemented as a safety feature whereby a power switch is automatically switched ON and OFF based on the pivoting movement of the door to the cabinet. It is understood that the invention could be used with other types of applications.

Many changes and modifications could be made to the invention without departing from the spirit thereof. The scope of these changes will become apparent from the appended claims.

I claim:

1. A multi-roll dispenser comprising:
a rear panel having a front side and a back side;
first and second mandrels extending from the rear panel, and configured for supporting first and second rolls of web material;
a cover pivotally coupled to the rear panel, wherein the cover and rear panel cooperate to define an opening generally beneath the first and second mandrels, and sized to allow web material to be withdrawn from the first and second rolls, and wherein the opening has a first portion positioned beneath the first post and a second portion positioned beneath the second mandrel;
a disc mounted to the rear panel and rotatable between a first position and a second position, the disc having a flange that closes the second portion of the opening when the disc is in the first position to prevent access to the second roll of web material and opens the second portion of the opening when the disc is in the second position to allow access to the second roll, the disc automatically movable from the first position to the second position when the first roll of web material is substantially exhausted;
a follower mounted to the disc and extending through the back side of the rear panel, wherein the follower is in a lower position when the disc is in the first position and is in a raised position when the disc is in the second position; and
a reset assembly interconnected between the cover and the rear panel, the reset assembly operative to move the follower from the raised position to the lowered position automatically when the cover is pivoted away from the rear panel.

2. The dispenser of claim 1 wherein the reset assembly includes a linkage assembly including:
a cover link having a first end coupled to the door and a second end pivotally coupled to an cam;
the cam having a first end coupled to the second end of the cover link, and having a second end pivotally coupled to a lift arm; and
wherein the lift arm is pivotal about a pivot point defined on the rear panel, and wherein the lift arm further has a follower engagement portion that abuts against an external surface of the pin and is operative to push the follower from the raised position to the lowered position when the cover is pivoted away from the rear panel.

3. The dispenser of claim 2 wherein the cam includes a curvilinear channel and the second end of the cover link includes a pin slidably received within the curvilinear channel, and wherein the channel defines a first range of motion for the front cover as the front cover is pivoted away from the rear panel and wherein the cam is pivotal relative to the lift arm to define a second range of motion for the front cover, and wherein the cam pivots relative to the lift arm to allow the front cover to move according to the second range of motion when the pin is pulled against a terminal end of the curvilinear channel.

4. The dispenser of claim 2 further comprising a spring having a stored tension that when released causes rotation of the disc.

5. The dispenser of claim 4 wherein the spring is loaded when the disc is moved to the first position.

6. The dispenser of claim 4 further comprising roll follower assembly having a roll follower arm pivotally coupled to the back side of the rear panel, and having a first end adapted to about against an external surface of the first roll of web material and a second adapted to engage the lift arm.

7. The dispenser of claim 6 wherein the roll follower arm is adapted to pivot from a raised position to a lowered position as the first roll of web material is exhausted.

8. The dispenser of claim 7 wherein the lift arm automatically lifts the roll follower arm from the lowered position to the raised position when the cover is pivoted away from the rear panel.

9. The dispenser of claim 1 wherein the first and second rolls of web material are first and second rolls of toilet paper.

10. The dispenser of claim 1 wherein the flange has a substantially arcuate shape, and wherein the flange is positioned generally between the first and second posts when the disc is in the second position.

11. A hands-free, multi-roll toilet paper dispenser comprising:
a housing including first and second mandrels for supporting first and second rolls of toilet paper, and further having a lower opening through which toilet paper from the first and second rolls may be dispensed;
a front cover pivotally coupled to a lower end of the housing, and movable from a closed position in which the first and second mandrels are inaccessible and an opened position in which the first and second posts are accessible;
a shield mounted to the housing and having a flange adapted to partially close the lower opening when in a lowered position and fully expose the lower opening when in a raised position;
a linkage interconnected between the shield and the front cover and operative to automatically move the shield to the lowered position when the cover is pivoted away from the housing, the linkage including:
a cover link having a first end coupled to the front cover and a second end pivotally coupled to an cam, the cam having a first end coupled to the second end of the cover link, and having a second end pivotally coupled to a lift arm; and
wherein the lift arm engages the shield to lower the shield to the lowered position when the front cover is moved to the opened position.

11. The dispenser of claim 10 wherein the shield includes a pin extending through a rear panel of the housing, and wherein the lift arm includes a pin engagement portion that abuts against an external surface of the pin and is operative to push the pin from a raised position to a lowered position when the cover is pivoted away from the rear panel to the opened position.

12. The dispenser of claim 11 wherein the cam includes a curvilinear channel and the second end of the cover link includes a pin slidably received within the curvilinear channel, and wherein the channel defines a first range of motion for the front cover as the front cover is pivoted away from the rear panel and wherein the cam is pivotal relative to the lift arm to define a second range of motion for the front cover, and wherein the cam pivots relative to the lift arm to allow the front cover to move according to the second range of motion when the pin is pulled against a terminal end of the curvilinear channel.

13. The dispenser of claim 12 wherein movement of the front cover in the second range of motion causes the lift arm to move from a raised position to a lowered position, and during said movement of the lift arm, the lift arm pushes the pin downward to reset the shield to the closed position.

14. A reset assembly interlinked between a cover and an enclosure, the reset assembly operative to return a rotary member from a released position to a reset position upon pivoting away of the cover from the enclosure, the reset assembly comprising:
a first linkage coupled to the cover and rotatable about a first axis of rotation as the cover is pivoted away from the enclosure; and
a second linkage interconnected between the first linkage and the rotary member, and configured to rotate the rotary member about a second axis of rotation, substantially orthogonal to the first axis of rotation, to return the rotary member from the released position to the reset position.

15. The reset assembly of claim 14 wherein the first linkage includes a first link coupled to the cover, a second link operatively associated with the second linkage, and an cam interconnected between the first and second links, and wherein the cam includes a curvilinear channel and the first link includes a first post extending into the curvilinear channel, and wherein the first post translates along the curvilinear channel during a first range of motion of the cover away from the enclosure.

16. The reset assembly of claim 15 wherein the cam is pivotal about the first axis of rotation after the post has been pulled against a terminal end of the curvilinear channel to permit further pivoting of the cover away from the enclosure in a second range of motion.

17. The reset assembly of claim 15 wherein the second linkage includes a lift arm pivotal about a third axis of rotation that is parallel to the second axis of rotation, the lift arm having a first end adapted to engage the rotary member and a second end that engages the second link, wherein the second end of the lift arm includes a slot and the second link has a second post that is received in and slidable along the slot such that as the second post moves along the slot, the lift arm is caused to rotate at the third axis of rotation.

18. The reset assembly of claim 17 wherein the slot defines a path a travel that is parallel to the first and third axes of rotation.
